(19) United States
(12) Patent Application Publication
(10) Pub. No.: US 2019/0375267 A1
(43) Pub. Date: Dec. 12, 2019

(54) VEHICLE SEAT AIR CONDITIONER

(71) Applicant: TOYOTA BOSHOKU KABUSHIKI KAISHA, Aichi-ken (JP)

(72) Inventors: Seiya NISHIMURA, Aichi-ken (JP); Fumitoshi AKAIKE, Aichi-ken (JP)

(73) Assignee: TOYOTA BOSHOKU KABUSHIKI KAISHA, Aichi-ken (JP)

(21) Appl. No.: 16/433,634

(22) Filed: Jun. 6, 2019

(30) Foreign Application Priority Data
Jun. 11, 2018 (JP) 2018-110969

(51) Int. Cl. B60H 1/00

(52) U.S. Cl. CPC B60H 1/00285; B60H 1/00564; B60H 1/00

(57) ABSTRACT

A vehicle seat air conditioner including: a blower duct; and a branch duct connected to the blower duct, the branch duct including: first and second branch pipe portions branching from a connection port in a radial direction opposite to each other; and first and second translation pipe portions extending in a translation direction intersecting with a branch direction, in which the connection port is in a first eccentric position deviated toward the first translation pipe portion from a central position between the first and second translation pipe portions, and in which the branch duct includes a convex portion that partitions a flow path and protrudes from an inner wall facing the connection port between the first and second branch pipe portions, the convex portion being in a second eccentric position on the inner wall deviated toward the first translation pipe portion from a center of the connection port.

### CROSS-REFERENCE TO RELATED APPLICATIONS

This application is based upon and claims the benefit of priority from prior Japanese patent application No. 2018-110969, filed on Jun. 11, 2018, the entire contents of which are incorporated herein by reference.

### TECHNICAL FIELD

The present disclosure relates to a vehicle seat air conditioner. Specifically, the present disclosure relates to a vehicle seat air conditioner including a blower duct configured to send air from a blower and a branch duct connected to the blower duct and configured to branch air from the blower duct.

### BACKGROUND

There is an air conditioner for a vehicle in the related art that blows air from a blower by branching the air via a branch duct as disclosed in JP-A-10-230733.

In the related art, the extending direction of the branch duct intersects with the flow direction of air from the blower. Accordingly, deviation may occur in the amount of air branched into each pipeline of the branch duct.

### SUMMARY

The present disclosure solves the above problem, and an object thereof is to make deviation hardly occur in the amount of air flowing to each pipeline of a branch duct from a blower.

In order to solve the problem, the vehicle seat air conditioner of the present disclosure includes the following units.

According to an aspect of the present disclosure, there is provided a vehicle seat air conditioner including: a blower duct configured to send air from a blower; and a branch duct connected to the blower duct and configured to branch air from the blower duct, the branch duct including: first and second branch pipe portions that branch from a connection port with the blower duct in a radial direction opposite to each other; and first and second translation pipe portions that extend translationally from the first and second branch pipe portions, respectively, in a translation direction intersecting with a branch direction of the first and second branch pipe portions, in which the connection port is in a first eccentric position deviated toward the first translation pipe portion from a central position between the first and second translation pipe portions, and in which the branch duct includes a convex portion that partitions a flow path at the connection port and protrudes from an inner wall facing the connection port so as to serve as a branch point between the first branch pipe portion and the second branch pipe portion, the convex portion being in a second eccentric position on the inner wall deviated toward the first translation pipe portion, which is in an eccentric direction of the connection port, from a center of the connection port.

### BRIEF DESCRIPTION OF DRAWINGS

FIG. 1 is a perspective view illustrating a schematic configuration of a vehicle seat air conditioner according to a first embodiment:

FIG. 2 is an enlarged perspective view of a main part of the vehicle seat air conditioner illustrating movement of a blower duct accompanying a seat slide;

FIG. 3 is a plan view of FIG. 2;

FIG. 4 is a front view of FIG. 2;

FIG. 5 is a perspective view of a branch duct alone;

FIG. 6 is a schematic view illustrating a state in which air is sent and branched to the branch duct from the blower duct in a first direction;

FIG. 7 is a schematic view illustrating a state in which air is sent and branched to the branch duct from the blower duct in a second direction: and

FIG. 8 is a schematic view illustrating a state in which air is sent and branched to the branch duct from the blower duct in a third direction.

### DETAILED DESCRIPTION

Embodiments of the present disclosure will be described below with reference to drawings.

### First Embodiment

<Schematic Configuration of Seat Air Conditioner 5>

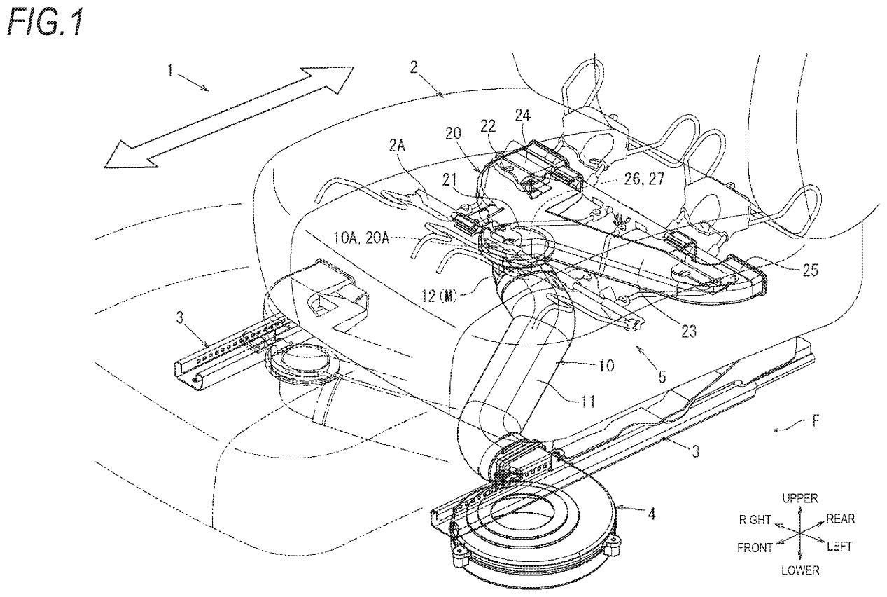

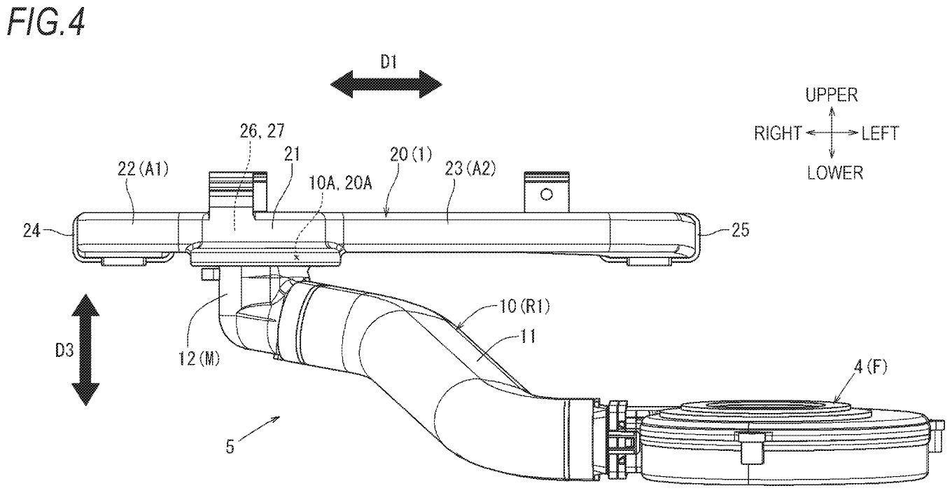

First, the configuration of the seat air conditioner 5 (vehicle seat air conditioner) according to the first embodiment will be described with reference to FIGS. 1 to 8. In the following description, front, rear, upper, lower, left, and right directions refer to those illustrated in the drawings. The “seat width direction” refers to the left-right direction of a seat 1 to be described below and the “seat height direction” refers to the upper-lower direction of the seat 1.

As illustrated in FIG. 1, the seat air conditioner 5 of the present embodiment has a pipeline structure in which air from a blower 4 installed on a floor F of an automobile is branched to the left and right and sent to the seat 1. The seat 1 includes a seat back (not illustrated) serving as a backrest portion of a seated occupant and a seat cushion 2 serving as a seating portion. The seat cushion 2 is mounted on the floor F via a pair of left and right slide rails 3 extending in the front-rear direction. With the above configuration, the seat 1 can adjust its position in the front-rear direction on the floor F via movement thereof on the slide rails 3 in the front-rear direction.

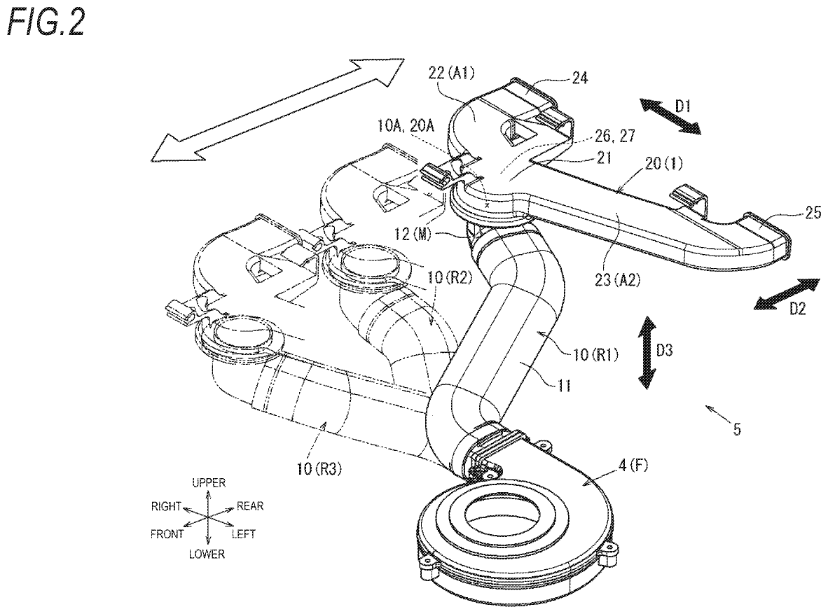

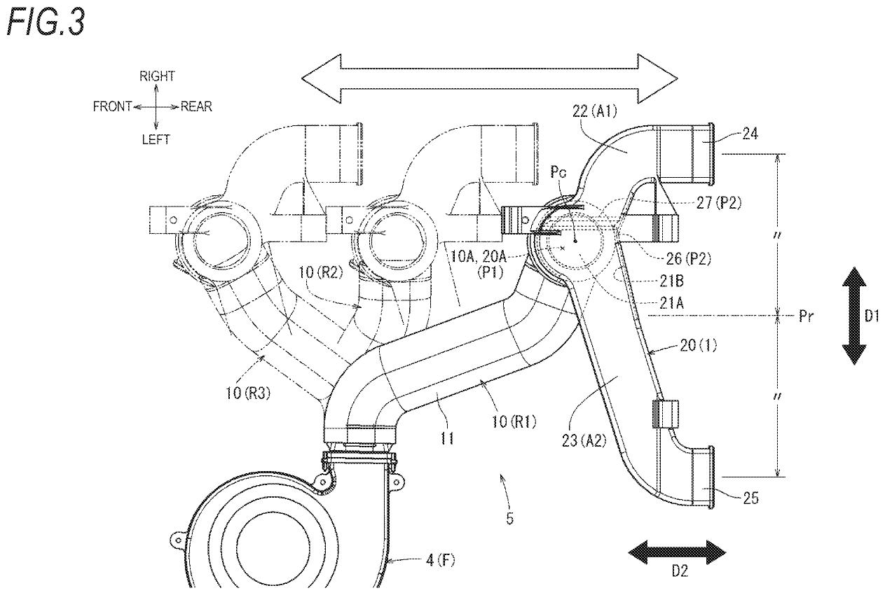

As illustrated in FIGS. 2 and 3, the seat air conditioner 5 includes a blower duct 10 connected to the blower 4 installed on the floor F of the automobile and sends air, and a branch duct 20 connected to the blower duct 10 and branches the sent air to the left and right. One end of the blower duct 10 is connected to an air outlet of the blower 4 and another end is connected to the branch duct 20. Specifically, as illustrated in FIG. 1, the blower 4 is located directly below the slide rail 3 provided on a left side of the seat 1 with the air outlet substantially straight facing a right side.

As illustrated in FIGS. 2 to 4, the blower duct 10 has a pipeline shape and includes a rubber extension pipe portion 11 that is connected to the blower 4 and extends to the right side, and an L-shaped tubular rotation pipe portion 12 that is connected to an end portion of the extension pipe portion 11 at an extension destination and is bent and extends such that an upward cylindrical connection port 10A is opened. By fitting the cylindrical connection port 10A opened upward from below to a cylindrical connection port 20A of the branch duct 20 that is opened downward, the blower duct 10 is connected to the branch duct 20 so that cylinders thereof are rotatable relative to each other in a sliding manner. The opening direction of the connection port 20A of the branch duct 20 is a direction D3 (corresponding to “intersecting direction” in the present disclosure) orthogonal to a branch direction D1 and a translation direction D2 of the branch duct 20 to be described below.

As illustrated in FIG. 1, the branch duct 20 is fixed to be hung from below to a formed wire 2A that bridges a frame (not illustrated) of the seat cushion 2. The formed wire 2A is a support member that bridges the frame (not illustrated) of the seat cushion 2 and supports a pad (not illustrated) from below. The pad elastically supports the load of the seated occupant in a planar manner.

The branch duct 20 has a pipeline shape and is formed of a resin. The branch duct 20 includes a connection pipe portion 21 including the cylindrical connection port 20A opened downward to connect the connection port 10A of the blower duct 10 as illustrated in FIGS. 2 to 4, first and second branch pipe portions 22 and 23 extending in the left-right direction (branch direction D1) in a branched manner from the connection pipe portion 21, and first and second translation pipe portions 24 and 25 extending substantially straight rearward (translation direction D2) from end portions of the first and the second branch pipe portions 22 and 23, respectively, at extension destinations.

With the above configuration, the seat air conditioner 5 can appropriately absorb deviation of a positional relationship between the branch duct 20 and the blower 4, which is caused by front-rear movement of the seat 1, by bending the blower duct 10 in the front-rear direction and rotating the rotation pipe portion 12 relative to the branch duct 20 (pivot structure M (corresponding to “switching structure” of the present disclosure): see FIGS. 2 and 3).

The extension pipe portion 11 is a large length so that the blower duct 10 can absorb the deviation of the positional relationship accompanying the front-rear movement of the seat 1 over a wide range in the seat front-rear direction. Accordingly, a center Pc of the cylindrical connection ports 10A and 20A of the blower duct 10 and the branch duct 20, respectively, is deviated to a first eccentric position P1 that is eccentric rightward from a central position Pr in the seat width direction on a lower portion of the seat cushion 2.

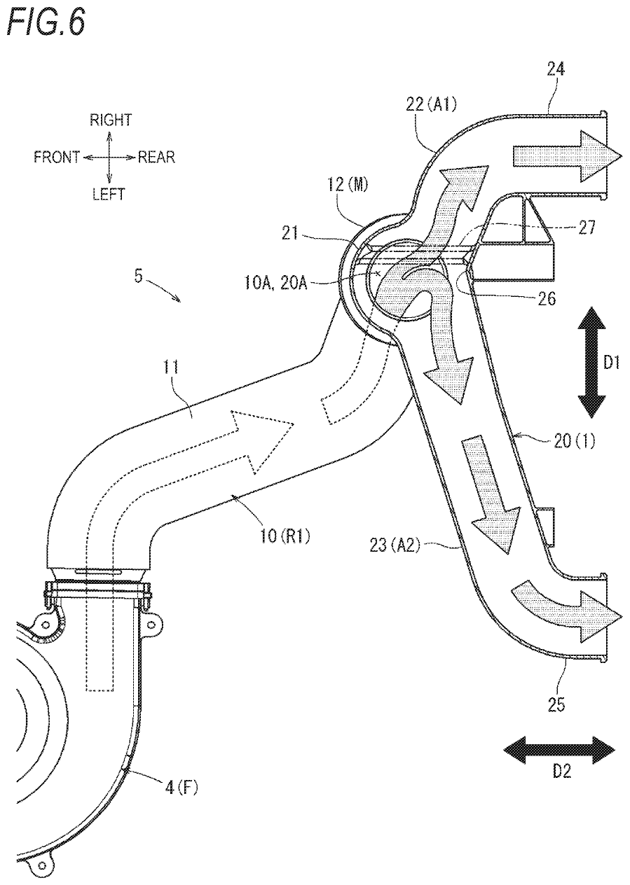

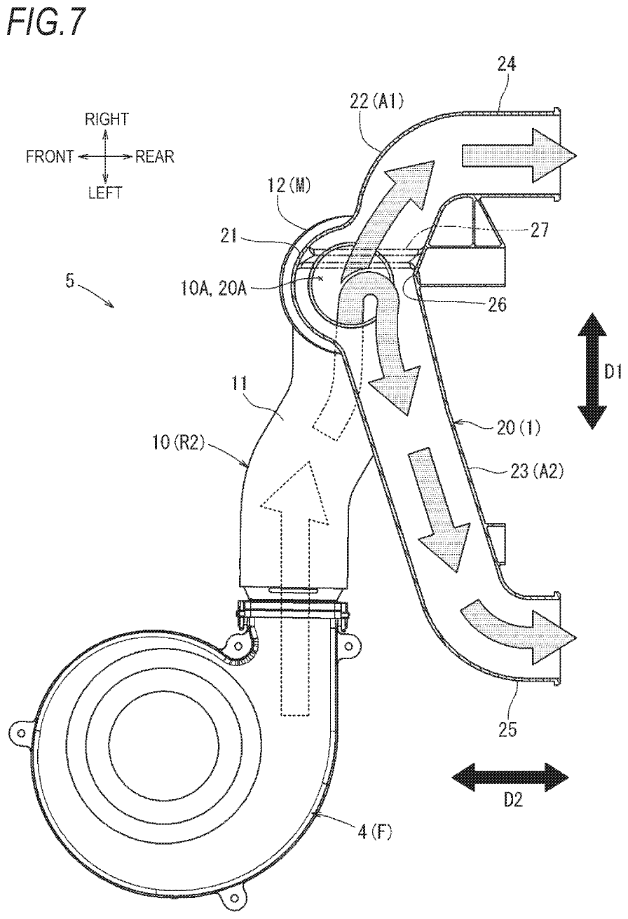

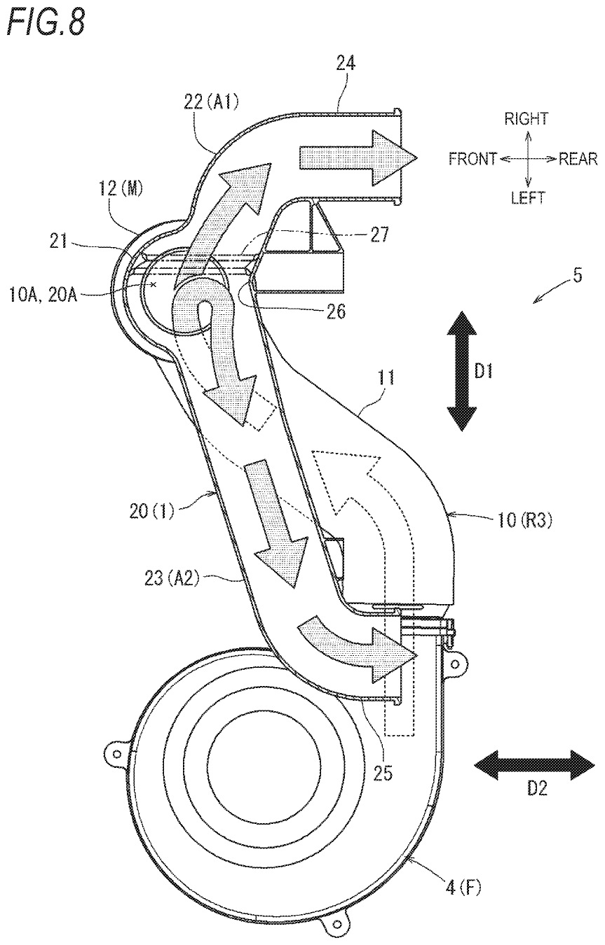

When a sliding position of the seat 1 is in the rear most, the blower duct 10 faces in a first direction R1 in which the extension pipe portion 11 extends diagonally rearward from a connection location with the blower 4 (see FIG. 6). When the sliding position of the seat 1 is in the middle between the rear most and the front most, the blower duct 10 faces in a second direction R2 in which the extension pipe portion 11 extends substantially straight rightward from the connection location with the blower 4 (see FIG. 7). When the sliding position of the seat 1 is in the front most, the blower duct 10 faces in a third direction R3 in which the extension pipe portion 11 extends diagonally frontward from the connection location with the blower 4 (see FIG. 8).

With the above configuration, no matter the blower duct 10 faces in the first direction R1, the second direction R2, or the third direction R3 illustrated in FIGS. 2 and 3, the extension pipe portion 11 extending toward the connection port 20A of the branch duct 20 is arranged rightward toward the flow direction of the first branch pipe portion 22 with respect to the flow direction of the second branch pipe portion 23 of the branch duct 20. Accordingly, no matter in any of the directions described above, the blower duct 10 blows air flowing through the inside thereof toward the first branch pipe portion 22 stronger than toward the second branch pipe portion 23 from the connection port 20A of the branch duct 20.

Therefore, in order to prevent the deviation in the amount of air toward the first branch pipe portion 22 and the second branch pipe portion 23 due to the rightward arrangement of the blower duct 10, the branch duct 20 is provided with a corner portion 26 and a ridge 27 that form a protruding partition in the pipeline so that a part of air flowing toward the first branch pipe portion 22 from the connection port 20A is turned to the second branch pipe portion 23. Further, the branch duct 20 is configured such that air is more likely to flow to the second branch pipe portion 23 by narrowing an inner cross-sectional area A1 of the first branch pipe portion 22 further than an inner cross-sectional area A2 of the second branch pipe portion 23. The corner portion 26 and the ridge 27 herein correspond to “convex portion” of the present disclosure.

Hereinafter, configurations of the corner portion 26 and the ridge 27 that form a protruding partition in the pipeline of the branch duct 20 will be described. As illustrated in FIG. 3, the first branch pipe portion 22 and the second branch pipe portion 23 of the branch duct 20 are formed into a bent V shape and respectively extend diagonally rearward to the left and right from the connection pipe portion 21. The bent corner portion 26, which serves as a bending point on a V-shaped inner wall formed by the first branch pipe portion 22 and the second branch pipe portion 23, protrudes on a side wall 21B (corresponding to “inner wall” of the present disclosure) serving as a rear wall that faces the connection port 20A of the connection pipe portion 21, so as to partition the first branch pipe portion 22 and the second branch pipe portion 23 in the seat width direction.

The corner portion 26 is in a second eccentric position P2 that is different from the center Pc of the connection port 20A of the branch duct 20 in the seat width direction and is eccentric to the right. With the above position arrangement, as illustrated in FIGS. 6 to 8, air flowing into the connection pipe portion 21 from the connection port 20A of the branch duct 20 is guided more likely to the second branch pipe portion 23 than to the first branch pipe portion 22 due to the partition of the corner portion 26.

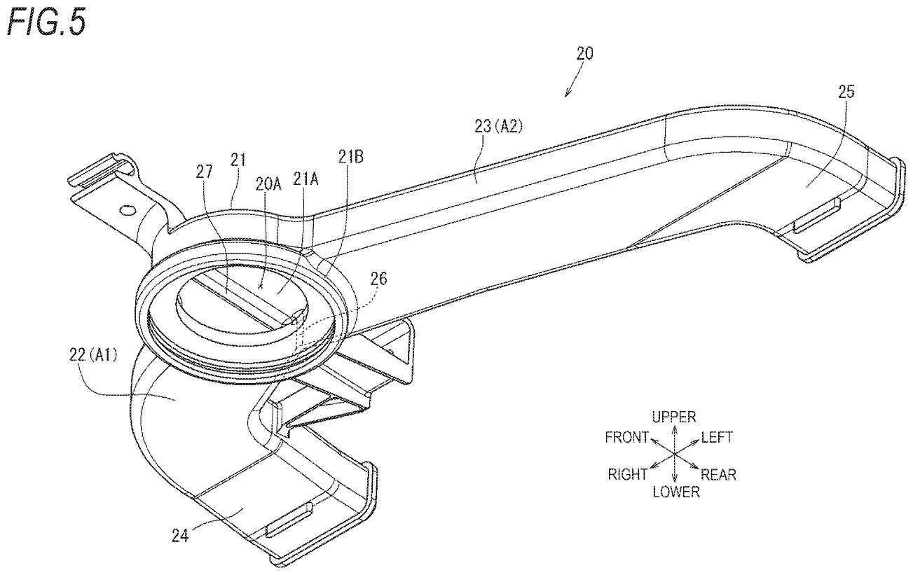

As illustrated in FIG. 5, the linear ridge 27, which extends in the front-rear direction and protrudes toward the connection port 20A, is formed on an opposing wall 21A (corresponding to “inner wall” of the present disclosure) serving as a top plate wall that faces the connection port 20A of the branch duct 20. Similarly to the corner portion 26, the ridge 27 is also in the second eccentric position P2 that is different from the center Pc of the connection port 20A of the branch duct 20 in the seat width direction and is eccentric to the right. With the above position arrangement, as illustrated in FIGS. 6 to 8, air flowing into the connection pipe portion 21 from the connection port 20A of the branch duct 20 is guided more likely to the second branch pipe portion 23 than to the first branch pipe portion 22 due to the partition of the ridge 27. More specifically, as illustrated in FIG. 3, the ridge 27 protrudes linearly across the entire front-rear width of the top plate wall in a position further deviated rightward of the corner portion 26.

### SUMMARY

In summary, the seat air conditioner (5) according to the present embodiment has the following configuration. The seat air conditioner (5) includes: a blower duct (10) configured to send air from a blower (4); and a branch duct (20) connected to the blower duct (10) and configured to branch air from the blower duct (10). The branch duct (20) includes first and second branch pipe portions (22, 23) that branch from a connection port (20A) with the blower duct (10) in a radial direction opposite to each other, and first and second translation pipe portions (24, 25) that extend translationally from the first and second branch pipe portions (22, 23), respectively, in a translation direction intersecting with a branch direction (D1) of the first and second branch pipe portions (22, 23).

The connection port (20A) is in a first eccentric position (P1) deviated toward the first translation pipe portion (24) from a central position (Pr) between the first and second translation pipe portions (24, 25). The branch duct (20) includes a convex portion (26, 27) that partitions a flow path at the connection port (20A) and protrudes from an inner wall (21A, 21B) facing the connection port (20A) so as to serve as a branch point between the first branch pipe portion (22) and the second branch pipe portion (23), the convex portion (26, 27) being in a second eccentric position (P2) on the inner wall (21A. 21B) deviated toward the first translation pipe portion (24), which is in an eccentric direction of the connection port (20A), from a center (Pc) of the connection port (20A).

With such a configuration, even when the connection port (20A) between the blower duct (10) and the branch duct (20) is in a position deviated from the central position (Pr) between the first and second translation pipe portions (24, 25), the amount of air flowing to each branch pipe portion (22, 23) of the branch duct (20) can be hardly deviated due to the partition by the convex portion (26, 27).

The connection port (20A) faces in an intersecting direction (D3) intersecting with the branch direction (D1) of the first and second branch pipe portions (22, 23) and the translation direction (D2) of the first and second translation pipe portions (24, 25). The blower duct (10) includes a switching structure (M) configured to switch a direction in which the blower duct faces between a first direction (R1) toward the translation direction (D2) around the center (Pc) of the connection port (20A) and a second direction (R2) toward an extending direction of the first branch pipe portion (22) compared with the first direction (R1).

With such a configuration, even the blower duct (10) is used in a mode in which a direction thereof can be switched around the connection port (20A) located at the eccentric position, deviation of the amount of air flowing to each branch pipe portion (22, 23) of the branch duct (20) can be prevented.

The first branch pipe portion (22) and the second branch pipe portion (23) are together formed into a bent V shape and respectively extend in the translation direction (D2) of the first and second translation pipe portions (24, 25). The convex portion includes a corner portion (26) at the V-shaped inner wall (21B) formed by bending the first branch pipe portion (22) and second branch pipe portion (23).

With such a configuration, the deviation of the amount of air can be prevented appropriately with a simple configuration in which the corner portion (26) at the bent inner wall (21B) of the first and second branch pipe portions (22, 23), which are formed into a bent V shape, is in the eccentric position.

The convex portion further includes, in addition to the corner portion (26), a ridge (27) that partitions the flow path at the connection port (20A) and protrudes toward the connection port (20A) from a location on an opposing wall (21A) facing the connection port (20A) of the branch duct (20), the location being deviated from a position of the corner portion (26) toward the first translation pipe portion (24).

Accordingly, the convex portion partitions the flow path at the connection port (20A) at a deviated position with two stages of the corner portion (26) and the ridge (27). Accordingly, the amount of air flowing to each branch pipe portion (22, 23) of the branch duct (20) can be hardly deviated.

An inner cross-sectional area (A1) of the first branch pipe portion (22) is smaller than an inner cross-sectional area (A2) of the second branch pipe portion (23).

Accordingly, the deviation of the amount of air flowing to each branch pipe portion (22, 23) by narrowing the first branch pipe portion (22) located to the eccentric side of the connection port (20A) further than the second branch pipe portion (23).

### OTHER EMBODIMENTS

Although embodiments of the present disclosure have been described above with one embodiment, the present disclosure can be implemented in various forms in addition to the above embodiment. For example, the vehicle seat air conditioner of the present disclosure can be applied to a seat air conditioner provided for various vehicles including trains, aircrafts, ships, and the like in addition to automobiles.

The blower duct may send air from the blower in the seat front-rear direction or the seat height direction in addition to the seat width direction. The branch duct may branch air from the blower duct in the seat front-rear direction or the seat height direction in addition to the seat width direction. The switching structure for switching between the first direction and the second direction of the blower duct may be caused by only bending the blower duct itself in addition to rotation around the connection port with the branch duct. In order to facilitate the bending of the blower duct itself, bellows may be provided in the blower duct.

A seat adjuster allowing the switching of the first direction and the second direction of the blower duct may be a transverse slide rail allowing position adjustment in the seat width direction, a seat lifter allowing position adjustment in the seat height direction, or an adjusting mechanism such as a recliner allowing angle adjustment of the backrest of the seat back, in addition to the slide rail allowing position adjustment in the seat front-rear direction.

The convex portion may be formed of only one of the corner portion (26) or the ridge (27) described in the above embodiment.

What is claimed is:

1. A vehicle seat air conditioner comprising:
a blower duct configured to send air from a blower; and
a branch duct connected to the blower duct and configured to branch air from the blower duct, the branch duct including:
first and second branch pipe portions that branch from a connection port with the blower duct in a radial direction opposite to each other; and
first and second translation pipe portions that extend translationally from the first and second branch pipe portions, respectively, in a translation direction intersecting with a branch direction of the first and second branch pipe portions,
wherein the connection port is in a first eccentric position deviated toward the first translation pipe portion from a central position between the first and second translation pipe portions, and
wherein the branch duct includes a convex portion that partitions a flow path at the connection port and protrudes from an inner wall facing the connection port so as to serve as a branch point between the first branch pipe portion and the second branch pipe portion, the convex portion being in a second eccentric position on the inner wall deviated toward the first translation pipe portion, which is in an eccentric direction of the connection port, from a center of the connection port.

2. The vehicle seat air conditioner according to claim 1,
wherein the connection port faces in an intersecting direction intersecting with the branch direction of the first and second branch pipe portions and the translation direction of the first and second translation pipe portions, and
wherein the blower duct includes a switching structure configured to switch a direction in which the blower duct faces between a first direction toward the translation direction around the center of the connection port and a second direction toward an extending direction of the first branch pipe portion compared with the first direction.

3. The vehicle seat air conditioner according to claim 1,
wherein the first branch pipe portion and the second branch pipe portion are together formed into a bent V shape and respectively extend in the translation direction of the first and second translation pipe portions, and
wherein the convex portion includes a corner portion at the V-shaped inner wall formed by bending the first branch pipe portion and second branch pipe portion.

4. The vehicle seat air conditioner according to claim 3,
wherein the convex portion further includes, in addition to the corner portion, a ridge that partitions the flow path at the connection port and protrudes toward the connection port from a location on an opposing wall facing the connection port of the branch duct, the location being deviated from a position of the corner portion toward the first translation pipe portion.

5. The vehicle seat air conditioner according to claim 1,
wherein an inner cross-sectional area of the first branch pipe portion is smaller than an inner cross-sectional area of the second branch pipe portion.
